(19) United States
(12) Patent Application Publication
(10) Pub. No.: US 2026/0336236 A1
(43) Pub. Date: Oct. 29, 2026

(54) METHOD OF MANUFACTURING A HOLLOW PART MADE OF COMPOSITE MATERIALS AND COMPRISING INTERNAL STIFFENERS

(71) Applicant: SAFRAN AIRCRAFT ENGINES, PARIS (FR)

(72) Inventors: Nicolas Quang-Ninh TRAN, MOISSY-CRAMAYEL (FR); Celia IGLESIAS CANO, MOISSY-CRAMAYEL (FR)

(73) Assignee: SAFRAN AIRCRAFT ENGINES, PARIS (FR)

(21) Appl. No.: 19/699,505

(22) Filed: Jun. 5, 2026

Related U.S. Application Data
(63) Continuation of application No. PCT/EP2024/084975, filed on Dec. 6, 2024.

(30) Foreign Application Priority Data
Dec. 7, 2023 (FR) 23/13725

(51) Int. Cl. B29C 70/54; B29C 70/48; B29K 105/08; B29L 31/08

(52) U.S. Cl. CPC B29C 70/54; B29C 70/48; B29K 2105/0845; B29K 2995/0059; B29L 2031/082

(57) ABSTRACT

A method for manufacturing a composite part includes producing a fibrous preform of the composite part, manufacturing mandrels from a molded soluble paste, and forming a fibrous reinforcement around each of the mandrels. The assembled mandrels are inserted into the preform at a location of a cavity to be formed in the composite part. The method includes inserting the preform incorporating the mandrels into a mold. The method includes injecting a resin into the mold to obtain the composite part, with the resin diffusing into the preform and the fibrous reinforcements. The method includes demolding the composite part and forming a channel in the composite part to reach the mandrels. The method includes injecting a solvent into the channel to dissolve the mandrels and form the cavity in the composite part. The fibrous reinforcements between the mandrels form stiffeners in the cavity.

### CROSS-REFERENCE TO RELATED APPLICATIONS

This application is a continuation of International Application No. PCT/EP 2024/084975, filed on Dec. 6, 2024, which claims priority to and the benefit of French Application No. FR 23/13725 filed on Dec. 7, 2023. The disclosures of the above applications are incorporated herein by reference.

### FIELD

The present disclosure relates to the manufacture of hollow aeronautical parts made of composite material.

### BACKGROUND

The statements in this section merely provide background information related to the present disclosure and may not constitute prior art.

In the field of aircraft engines, the turbomachine blades are commonly made of composite materials such as organic matrix composites (OMCs) in order to reduce their weight while providing mechanical properties equivalent or superior to those of metal. Indeed, improving the turbomachine performance, particularly with regard to fuel consumption, may involve a reduction in weight. These blades may be rotor or stator blades of ducted or unducted turbomachines, for example outlet guide vanes (OGVs).

In the case of composite-material blades obtained by three-dimensional weaving, the composite material located at the core of the blade has only a limited influence on the mechanical performance of the part, although it represents a non-negligible portion of the blade weight. Thus, it is advantageous to manufacture hollow blades, either by stacking two-dimensional fibrous reinforcements which are subsequently densified with resin, or by three-dimensional weaving of a preform which is subsequently densified.

A common technique for manufacturing hollow blades consists in forming, within the part, a cavity filled with high-density foam. The foam advantageously facilitates the manufacturing because the thickness variations are accommodated not by the preform using ply drop-offs, but by the foam. As a result, the reduction in material scrap and the repeatability are considerable. Furthermore, in the case of a dry lay-up or prepreg process, shaping is easier to perform on foam, which then acts as a support. However, the foam has several drawbacks. Its cost is significant. It is fragile, absorbs moisture, and ages relatively quickly. Furthermore, the interfaces with the foam are more difficult to inspect by ultrasound. As a result, it is desired to control the humidity environment and to limit exposure thereof to moisture.

It is also known to use a metal mandrel to form a cavity within a part. If the core of the part around the mandrel is not fusible, the mandrel greatly constrains the geometry of the cavity in order to allow demolding, which is incompatible with the complex shapes of next-generation parts. If the core is fusible, the process of melting the core after curing of the part adds a manufacturing step and often leaves numerous particles (FOD—“Foreign Object Detected”) on the part. This process also has a high cost, and in some cases the curing step desired for melting has a non-negligible impact on the mechanical properties of the part. It should also be noted that this curing step reduces the repair potential of the part (linked to the cumulative time during which the part is subjected to a temperature above 120 °C).

Another technique for producing hollow parts having a non-demoldable cavity consists in shaping and extracting internal molding portions. However, this technique desires specific shaping and extraction tooling.

It is therefore desirable to produce a highly hollowed part while providing mechanical strength suited to its intended use. It is also desirable for the obtained mechanical strength to be compatible with that of turbomachine blades, whether ducted or unducted, and whether stationary or rotating.

### SUMMARY

This section provides a general summary of the disclosure and is not a comprehensive disclosure of its full scope or all of its features.

The present disclosure provides for the manufacture of aircraft turbomachine blades by methods involving resin injection into a fibrous preform, although not exclusively. More specifically, the present disclosure relates to a method for manufacturing such a hollow aeronautical part.

Forms of the present disclosure relate to a method for manufacturing a composite-material part comprising operations consisting in: producing a fibrous preform of the composite part; manufacturing mandrels from a molded soluble paste; forming a fibrous reinforcement around each mandrel; assembling the mandrels covered with the fibrous reinforcement; inserting the assembled mandrels into the fibrous preform at a location of a cavity to be formed in the composite part, the mandrels and the fibrous preform defining the geometry of the cavity; inserting the fibrous preform incorporating the mandrels into an injection mold; injecting a resin into the injection mold in order to obtain the composite part, the resin diffusing into the fibrous preform and into the fibrous reinforcement around each mandrel; demolding the composite part after polymerization of the resin; forming a channel in the composite part to reach the mandrels from the exterior of the composite part; and injecting a solvent into the channel in order to dissolve the mandrels and form the cavity in the composite part, the fibrous reinforcements between the mandrels being configured to form stiffeners between opposite walls of the cavity.

According to one form, the formation of the channel is carried out either during the formation of the fibrous reinforcement and the preform and during injection molding, or by a drilling operation after demolding of the composite part.

According to one form, the method comprises, prior to the injection molding, an operation of shaping the fibrous preform in a dry state, or alternatively an operation of shaping the fibrous preform in a wet state, followed by a drying operation of the fibrous preform.

According to one form, the method comprises a lay-up operation of the fibrous preform prior to the injection molding.

According to one form, the composite part is a turbomachine part, or a stationary or rotating blade of a ducted turbomachine, or a stationary or rotating blade of an unducted turbomachine.

Forms of the present disclosure may also relate to a composite-material part comprising an outer skin, an inner cavity, and stiffeners connecting opposite faces of the cavity together, the stiffeners and the skin being formed in a same resin in which fibers are embedded.

According to one form, the composite-material part is a turbomachine part, or a stationary or rotating blade of a ducted turbomachine, or a stationary or rotating blade of an unducted turbomachine.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIGS. 1A and 1B are schematic front views of an unducted turbomachine blade and of a ducted turbomachine blade, respectively;

FIG. 2 is a schematic cross-sectional view of the blade of FIG. 1A or 1B;

FIG. 3 is a schematic cross-sectional view of the blade of FIG. 1A or 1B, according to one form;

FIGS. 4A to 4H are cross-sectional views of parts illustrating a method for manufacturing a blade, according to one form;

FIG. 5 is a schematic perspective view of a mold;

FIG. 6 is a schematic perspective view of a 3D-woven composite preform.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

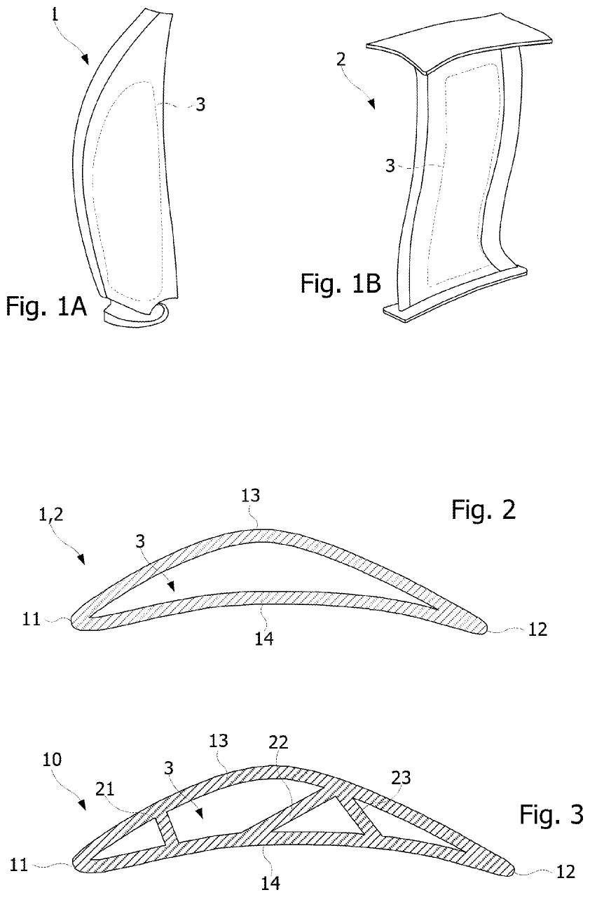

FIG. 1A illustrates a stationary or rotating unducted turbomachine blade 1. FIG. 1B illustrates a stationary ducted turbomachine blade 2. In the example of FIG. 1A, the blade 1 is a stationary outlet blade intended to be arranged downstream of the blades of an unducted fan of a flow straightener or OGV in order to straighten a secondary airflow. In the example of FIG. 1B, the blade 2 is an outlet guide vane intended to be arranged in an OGV, downstream of the blades of a ducted fan. These examples are non-limiting, the present disclosure also applies, for example, to fan blades or any other stationary or rotating fan module made of an organic composite material (OMC) with a fibrous reinforcement embedded in an OMC matrix. The blade 1, 2 conventionally comprises a leading edge 11, a trailing edge 12, a pressure side 13, and a suction side 14.

According to one form illustrated in FIGS. 1A, 1B and 2, the blade 1, 2 has an internal cavity 3 extending through most of the volume of the blade in order to reduce its weight. However, the presence of such a cavity 3 greatly reduces the mechanical strength of the part 1, 2. We have discovered that, without significantly affecting the weight of the part, stiffeners connecting opposite walls of the cavity 3 together may be formed inside the cavity 3 of the blade. Thus, FIG. 3 illustrates a blade 10 differing from the blades 1, 2 in that the cavity 3 of the blade comprises stiffeners 21, 22, 23 connecting opposite walls of the cavity together. In the particular case of the blade 10, the stiffeners connect the walls forming the pressure side 13 and the suction side 14 together and thereby make it possible to stiffen these walls.

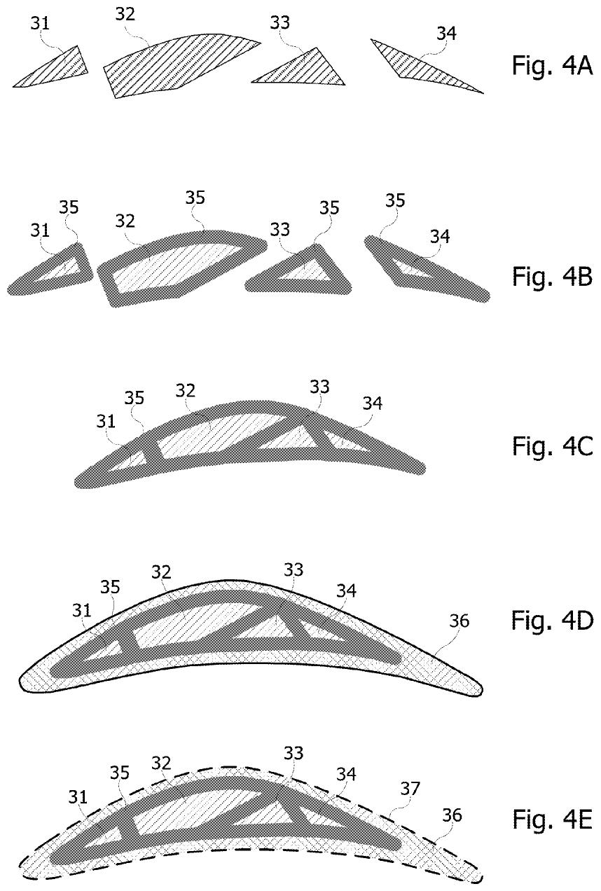

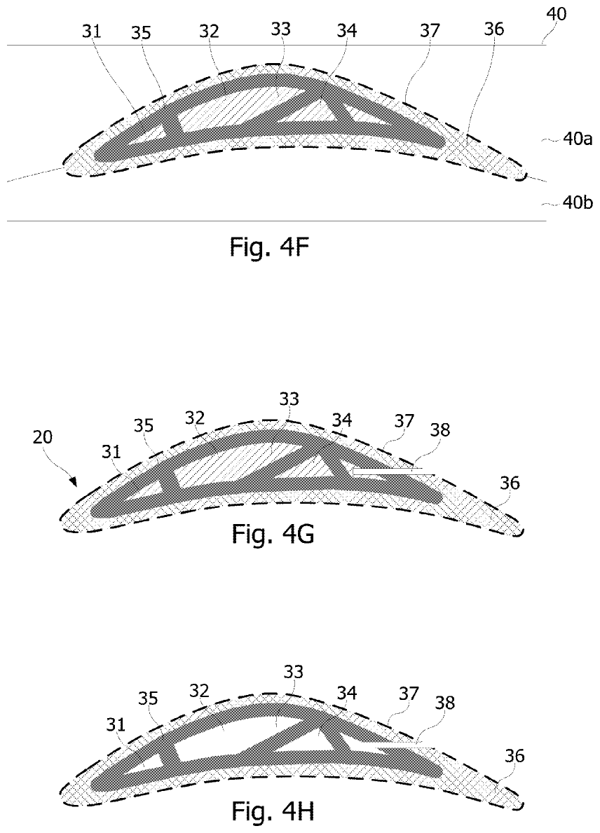

FIGS. 4A to 4H illustrate various operations of the method for manufacturing the blade 10 with the cavity 3 and the stiffeners 21, 22, 23. FIG. 4A illustrates rigid and soluble mandrels 31, 32, 33, 34 intended to be used as tooling allowing to produce the internal walls of the cavity 3 with the stiffeners 21, 22, 23. Thus, the mandrels 31-34 have the shape of portions intended to remain hollow in the blade 10.

The mandrels 31-34 may be produced by molding a fluid (paste or liquid) made of a material capable of hardening and soluble in an appropriate solvent, according to the following. The fluid may be obtained by mixing various compositions in powder form and heating the mixture in order to liquefy it. The fluid is then poured into molds having the desired shapes and subsequently cooled in the molds. The molding may be carried out by gravity or under pressure, for example by injection. The mandrels 31, 32, 33, 34 are subsequently demolded.

The powder mixture may comprise a nitrate content greater than 60%, thereby facilitating the subsequent dissolution of the mandrels. For example, the powder mixture may comprise sodium nitrate (NaNO₃), potassium nitrate (KNO₃), and zirconium silicate (ZrSiO₄). According to one exemplary form, the powder mixture comprises mass contents of 13.3% sodium nitrate, 53.4% potassium nitrate, and 33.3% zirconium silicate (ZrSiO₄). The mass contents are given relative to the total weight of the composition. This mixture may be maintained at a temperature between 315 °C and 325 °C throughout the mixing operation. The gravity casting may be carried out in the mold heated to a temperature between 180 °C and 250 °C. The solidification of the mandrels is achieved by cooling to room temperature.

FIG. 4B illustrates draping the demolded mandrels 31, 32, 33, 34 with a fibrous reinforcement 35 shaped or draped directly onto the mandrels. The fibrous reinforcement 35 may be produced by forming a reinforcement layer by spraying or winding fibers. The fibrous reinforcement may for example be produced by additive manufacturing using a thermoplastic filament that is water-soluble and mechanically resistant up to a temperature of 130 °C, such as ST130. The fibrous reinforcement may also be formed from fibers, notably carbon fibers (for example IM7, T1100), glass fibers, aramid fibers, or plant fibers. The fibrous reinforcement does not necessarily cover the entire surface of the mandrels. In this case, the portions not covered by the fibers may be filled by the resin of the composite forming the fibers, thus with a local fiber volume fraction equal to zero.

FIG. 4C illustrates assembling the mandrels 31, 32, 33, 34 with their respective fibrous reinforcements 35 in order to form the blade 10. Thus, the free surface of the fibrous reinforcement 35 covering the assembled mandrels substantially corresponds to the shape of an internal core of the blade 10.

FIG. 4D illustrates inserting the assembled mandrels 31-34 with the fibrous reinforcement 35 into a preform or blank 36 of the blade 10. To this end, the preform 36 may have been previously moistened in order to facilitate shaping thereof around the assembled mandrels 31-34.

The fibrous preform 36 is for example formed by three-dimensional weaving in which the yarns are interlaced three-dimensionally (so-called “3D interlock” weaving). The preform 36 may also be obtained by braiding or draping unidirectional plies or formed from discontinuous short fibers. The manufacture of such a fibrous preform is known to those skilled in the art and will not be described in detail herein. It should however be noted that the fibrous preform 36 comprises a separation region forming an opening allowing the insertion of the assembled mandrels 31-34 with the fibrous reinforcement 35. This opening may be formed, for example, in a portion of the preform corresponding to the root of the blade to be produced.

FIG. 4E illustrates shaping the preform 36 covering the assembled mandrels 31-34 with the fibrous reinforcement 35. This aims at correctly positioning the fibers of the preform 36 according to the shape and structure of the final part 10. To this end, the preferential regions (the weakest regions) are more densely stiffened in order to improve their structural resistance to impacts and the like, the objective being to obtain satisfactory mechanical properties. This comprises performing a drying operation of the preform 36 in the presence of the mandrels 31-34 in order to fix the shape of the preform. This drying operation is conventionally performed by heating to a temperature lower than 120 °C depending on the nature of the fibers. In this instance, the fibers of the preform 36 may notably be carbon, glass, or aramid fibers. This also comprises a draping operation consisting in covering the preform with a layer 37.

FIG. 4F illustrates a molding operation of the preform 36 as illustrated in FIG. 4E. This provides shaping, densification, and consolidation of the part. This is performed by placing the preform 36 with the draping 37 in a mold 40, for example comprising two shells 40a, 40b delimiting therebetween the volume of the part 10 to be produced. The molding operation itself may be performed by injecting a thermosetting or thermoplastic resin into the mold, for example according to the RTM (“Resin Transfer Molding”) technique. In one form, the resin comprises a polymer. In one form, the polymer is epoxy, bismaleimide, or polyimide. A heat treatment facilitating the polymerization or curing of the resin is subsequently carried out. To this end, the entire mold is heated in order to cure the resin and obtain the final rigid part. After polymerization of the resin injected into the mold, the part is demolded.

It should be noted that the drying operation may be carried out in the mold 40 before the molding illustrated in FIG. 4F. A system for maintaining the mandrels 34-36 in their final positions in the mold may be implemented during the drying. Maintaining the mandrels in a correct position makes it possible to obtain fiber volume fractions and compaction levels of the fibers of the preform 36, thereby providing improved mechanical strength to the final part.

FIG. 4G illustrates a drilling of the demolded part 20 in order to form one or more channels 38 from the exterior of the part 20 to the mandrels 31-34. In the case where the part 20 is a blade, each channel 38 may be formed from the trailing edge 12.

It should be noted that this drilling operation may be avoided or reduced by forming all or part of the channels 38 during the formation of the mandrels, the preform 36, and the draping 37. According to one example, the mandrels 34-36 and the channels are formed as a single part (by molding or bonding), including connections between the mandrels. The mandrels may also be assembled to form a rigid assembly using rigid tubes connecting the mandrels together and connecting one of the mandrels to the exterior of the part 20. The tubes may for example be metallic. However, a drilling operation may be provided in order to connect all of the mandrels to the exterior of the part 20.

FIG. 4G illustrates removing the mandrels 31-34 by dissolution. This may be performed by injection or spraying, into the channel or channels 38, of a solvent adapted to the material forming the mandrels. In the case where the mandrels are made from the powder mixture described previously, the solvent may be heated and pressurized water, for example at a temperature comprised between 80 °C and 90 °C and at a pressure greater than or equal to 40 bar. The use of pressurized hot water makes it possible to provide complete removal of the mandrels without residues in the part. The channels 38 may then be sealed, for example using a silicone such as RTV (“Room-Temperature-Vulcanizing”) silicone or force-fitted plugs.

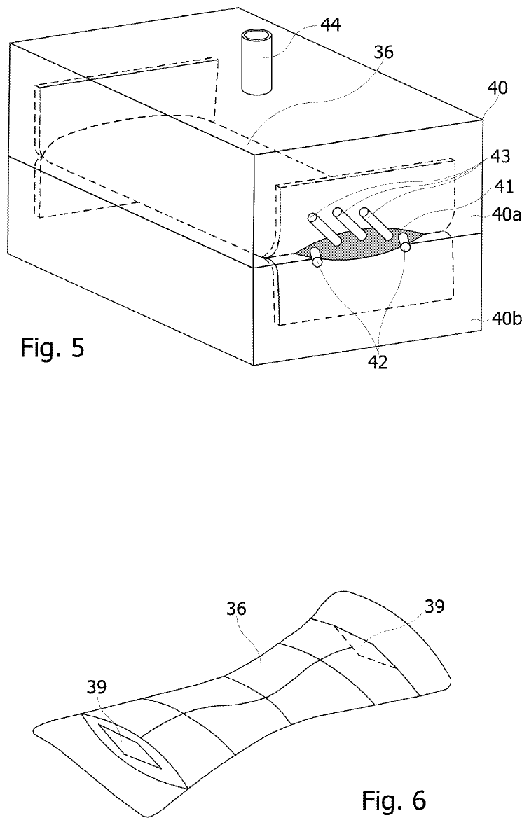

FIG. 5 illustrates the mold 40, a mold filling orifice 44, a holding tool 41 fixed to the mold 40 by fastening members 42, and positioning pins 43 for positioning the mandrels in the mold. The operations illustrated in FIGS. 4C and 4D may be performed by positioning the preform 36 in the mold 40, the preform being shaped using tracers, for example made of glass fiber, or by laser projection. Such tracers are described, for example, in the document entitled Bjorn's Corner: Turbofan engine challenges; Part 2 published by Leeham News and Analysis.

Next, the mandrels 31-34 and then the pins 43 are inserted into the preform 36 through an opening formed in the preform. Finally, the holding tool 41 is fastened to the mandrels 31-34 by means of the pins 43. FIG. 6 illustrates the preform 36 and an opening 39 through which the mandrels 31-34 and the pins 43 may be introduced. In the example of FIG. 6, two openings 39 are formed in the preform 36 at opposite ends thereof.

It will be readily apparent to those skilled in the art that the present disclosure is capable of various alternative forms and various applications. In particular, the present disclosure is not limited to the manufacture of turbomachine blades, but may apply to any part, notably an aeronautical part, made of composite materials and intended to be lightened by the formation of one or more internal cavities.

Furthermore, the mandrels, and therefore the molds used to form the mandrels, do not have to have a shape reflecting the shape of the part to be produced.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A method for manufacturing a part composed of a composite material, the method comprising:
producing a fibrous preform;
manufacturing mandrels from a molded soluble paste;
forming a fibrous reinforcement around each of the mandrels;
assembling the mandrels covered with the fibrous reinforcement to form assembled mandrels;
inserting the assembled mandrels into the fibrous preform at a location of a cavity to be formed in the part, the assembled mandrels and the fibrous preform defining a geometry of the cavity;
inserting the fibrous preform incorporating the assembled mandrels into an injection mold;
injecting a resin into the injection mold to form the part, the resin diffusing into the fibrous preform and the fibrous reinforcement around each of the mandrels;
demolding the part after polymerization of the resin;
forming a channel in the part to reach the mandrels from an exterior of the part; and
injecting a solvent into the channel to dissolve the mandrels and form the cavity in the part, the fibrous reinforcement between the mandrels being configured to form stiffeners between opposite walls of the cavity.

2. The method according to claim 1, wherein the forming of the channel is performed either during the forming of the fibrous reinforcement, the producing of the fibrous preform, and the injecting of the resin into the injection mold, or by drilling after demolding of the part.

3. The method according to claim 1, comprising, before the injecting of the resin into the injection mold, shaping the fibrous preform in a dry state, or shaping the fibrous preform in a wet state, followed by a drying operation of the fibrous preform.

4. The method according to claim 1, comprising draping of the fibrous preform before injection molding.

5. The method according to claim 1, wherein the part is a turbomachine part, a stationary or rotating blade of a ducted turbomachine, or a stationary or rotating blade of an unducted turbomachine.

6. A part composed of a composite material, comprising:
an outer skin composed of a resin;
an internal cavity; and
a plurality of stiffeners connecting opposite faces of the internal cavity together, the plurality of stiffeners composed of the resin and fibers are embedded in the resin.

7. The part according to claim 6, wherein the part is a turbomachine part, a stationary or rotating blade of a ducted turbomachine, or a stationary or rotating blade of an unducted turbomachine.
